(19) United States
(12) Patent Application Publication
(10) Pub. No.: US 2019/0004816 A1
(43) Pub. Date: Jan. 3, 2019

(54) SYSTEMS AND METHODS FOR HETEROGENEOUS SYSTEM ON A CHIP SERVERS

(71) Applicant: Dell Products L.P., Round Rock, TX (US)

(72) Inventors: Mukund P. KHATRI, Austin, TX (US); Ramesh RADHAKRISHNAN, Austin, TX (US)

(73) Assignee: Dell Products L.P., Round Rock, TX (US)

(21) Appl. No.: 15/637,102

(22) Filed: Jun. 29, 2017

(51) Int. Cl. G06F 9/44

(52) U.S. Cl. CPC G06F 9/4405; G06F 15/7807; G06F 9/4403

(57) ABSTRACT

In accordance with embodiments of the present disclosure, an information handling system may include a circuit board comprising a first system on a chip having a first processor, a second system on a chip having a second processor, the first processor and the second processor being heterogeneous with respect to one another, and a management controller communicatively coupled to the first system on a chip and the second system on a chip and configured to, based on a user configuration, select one or both of the first system on a chip and the second system on a chip for enablement during a boot session of the information handling system.

### TECHNICAL FIELD

The present disclosure relates in general to information handling systems, and more particularly to methods and systems for providing server information handling systems with heterogeneous systems on a chip.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Servers with general purpose processors are oftentimes not efficient across all processing workloads. Accordingly, many users desire to use multiple servers each with a different type of processor in order to provide the necessary compute capability, but may be limited by physical space available in data centers and power constraints from providing both types of servers.

### SUMMARY

In accordance with the teachings of the present disclosure, the disadvantages and problems associated with supporting multiple types of processors in a data center may be reduced or eliminated.

In accordance with embodiments of the present disclosure, an information handling system may include a circuit board comprising a first system on a chip having a first processor, a second system on a chip having a second processor, the first processor and the second processor being heterogeneous with respect to one another, and a management controller communicatively coupled to the first system on a chip and the second system on a chip and configured to, based on a user configuration, select one or both of the first system on a chip and the second system on a chip for enablement during a boot session of the information handling system.

In accordance with these and other embodiments of the present disclosure, a method may include, in a circuit board comprising a first system on a chip having a first processor and a second system on a chip having a second processor, the first processor and the second processor being heterogeneous with respect to one another receiving a user configuration, and based on the user configuration, selecting one or both of the first system on a chip and the second system on a chip for enablement during a boot session of an information handling system comprising the circuit board.

In accordance with these and other embodiments of the present disclosure, an article of manufacture may include a non-transitory computer-readable medium and computer-executable instructions carried on the computer readable medium, the instructions readable by a processor, the instructions, when read and executed, for causing the processor to, in a circuit board comprising a first system on a chip having a first processor and a second system on a chip having a second processor, the first processor and the second processor being heterogeneous with respect to one another: receive a user configuration; and based on the user configuration, select one or both of the first system on a chip and the second system on a chip for enablement during a boot session of an information handling system comprising the circuit board.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of another example information handling system, in accordance with embodiments of the present disclosure; and

FIG. 3 illustrates a flow chart of an example method for configuring an information handling system having heterogeneous processors on a single motherboard, in accordance with embodiments of the present disclosure.

### DETAILED DESCRIPTION

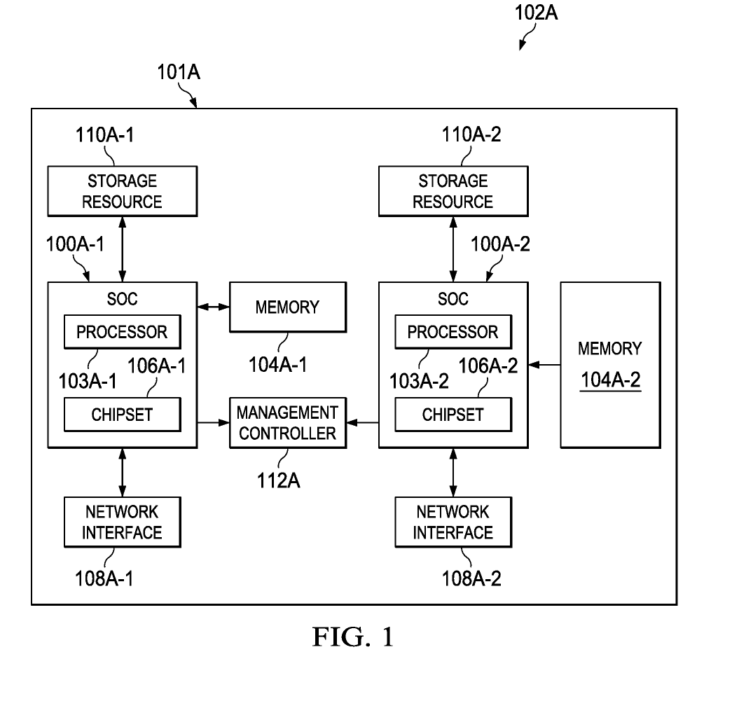

Preferred embodiments and their advantages are best understood by reference to FIGS. 1 through 3, wherein like numbers are used to indicate like and corresponding parts. For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102A, in accordance with embodiments of the present disclosure. In some embodiments, information handling system 102A may comprise or be an integral part of a server. As depicted in FIG. 1, information handling system 102A may include a motherboard 101A.

Motherboard 101A may include a circuit board configured to provide structural support for one or more information handling resources of information handling system 102A and/or electrically couple one or more of such information handling resources to each other and/or to other electric or electronic components external to information handling system 102A. As shown in FIG. 1, motherboard 101A may comprise a plurality of systems on a chip (SOCs) 100A (e.g., SOC 100A-1 and SOC 100A-2), a plurality of memories 104A (e.g., memory 104A-1 and memory 104A-2) each communicatively coupled to a respective SOC 100A, a plurality of storage resources 110A (e.g., storage resource 110A-1 and storage resource 110A-2) each communicatively coupled to a respective SOC 100A, a plurality of network interfaces 108A (e.g., network interface 108A-1 and network interface 108A-2) each communicatively coupled to a respective SOC 100A, and a management controller 112A communicatively coupled to SOCs 100A.

An SOC 100A may comprise an integrated circuit that integrates multiple components of an information handling system into a single integrated circuit package. As shown in FIG. 1, an SOC 100A may include a processor 103A (e.g., processor 103A-1 and processor 103A-2) and a chipset 106A (e.g., chipset 106A-1 and chipset 106A-2) communicatively coupled to processor 103A.

A processor 103A may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103A may interpret and/or execute program instructions and/or process data stored in a memory 104A and/or another component of information handling system 102A.

A chipset 106A may include any system, device, or apparatus configured to control certain data paths (e.g., data flow between a processor 103A and other components of information handling system 102A) and/or interactions of components of information handling system 102A. Thus, a chipset 106A may include a set of specialized chips for allowing communication between various components of information handling system 102A. For example, a chipset 106A may include northbridge and southbridge chips linking its associated processor 103A for I/O communication with other components or peripherals of information handling system 102A, e.g., a memory 104A, a storage resource 110A, a network interface 108A, and/or management controller 112A.

In embodiments of the present disclosure, processors 103A-1 and 103A-2 may be heterogeneous with respect to each other, meaning the processors 103A significantly differ in at least one material respect (e.g., vendor, processing capability, etc.).

A memory 104A may be communicatively coupled to an associated processor 103A via a chipset 106A and may include any system, device, or apparatus configured to retain program instructions and/or data for a period of time (e.g., computer-readable media). A memory 104A may include RAM, EEPROM, a PCMCIA card, flash memory, magnetic storage, opto-magnetic storage, or any suitable selection and/or array of volatile or non-volatile memory that retains data after power to information handling system 102A is turned off.

A network interface 108A may comprise any suitable system, apparatus, or device operable to serve as an interface between information handling system 102A and/or one or more other information handling systems. Network interface 108A may enable information handling system 102A to communicate using any suitable transmission protocol and/or standard. In these and other embodiments, network interface 108A may comprise a network interface card, or “NIC.”

A storage resource 110A may be communicatively coupled to an associated processor 103A via a chipset 106A. A storage resource 110A may include any system, device, or apparatus operable to store information processed by processor 103A. A storage resource 110A may include, for example, one or more direct access storage devices (e.g., hard disk drives).

Management controller 112A may be configured to provide out-of-band management facilities for management of information handling system 102A. Such management may be made by management controller 112A even if information handling system 102A is powered off or powered to a standby state. In certain embodiments, management controller 112A may include or may be an integral part of a baseboard management controller (BMC), a remote access controller (e.g., a Dell Remote Access Controller or Integrated Dell Remote Access Controller), or an enclosure controller. In other embodiments, management controller 112A may include or may be an integral part of a chassis management controller (CMC).

In addition to motherboard 101A, processors 103A, chipsets 106A, memories 104A, network interfaces 108A, storage resources 110A, and management controller 112A, information handling system 102A may include one or more other information handling resources.

As shown, in information handling system 102A, each SOC 100A may have information handling resources solely dedicated to such SOC 100A and not accessible to another SOC 100A within information handling system 102A. For example, memory 104A-1, network interface 108A-1, and storage resource 110A-1 may be dedicated to SOC 100A-1, while memory 104A-2, network interface 108A-2, and storage resource 110A-2 may be dedicated to SOC 100A-2.

Despite certain information handling resources being dedicated to specific SOCs 100A, management controller 112A may instead be shared among SOCs 100A, and thus management controller 112A may manage operation of SOCs 100A and their associated information handling resources. In operation, upon a boot or other initialization of information handling system 102A, management controller 112A may (e.g., based on a user selection or other configuration) select which of SOC 100A-1 and SOC 100A-2 may be enabled during such boot session, and the information handling resources associated with the selected SOC 100A may be discovered and powered on during the boot process. In some embodiments, management controller 112A may (e.g., based on a user selection or other configuration) enable both of SOC 100A-1 and SOC 100A-2 during a boot session.

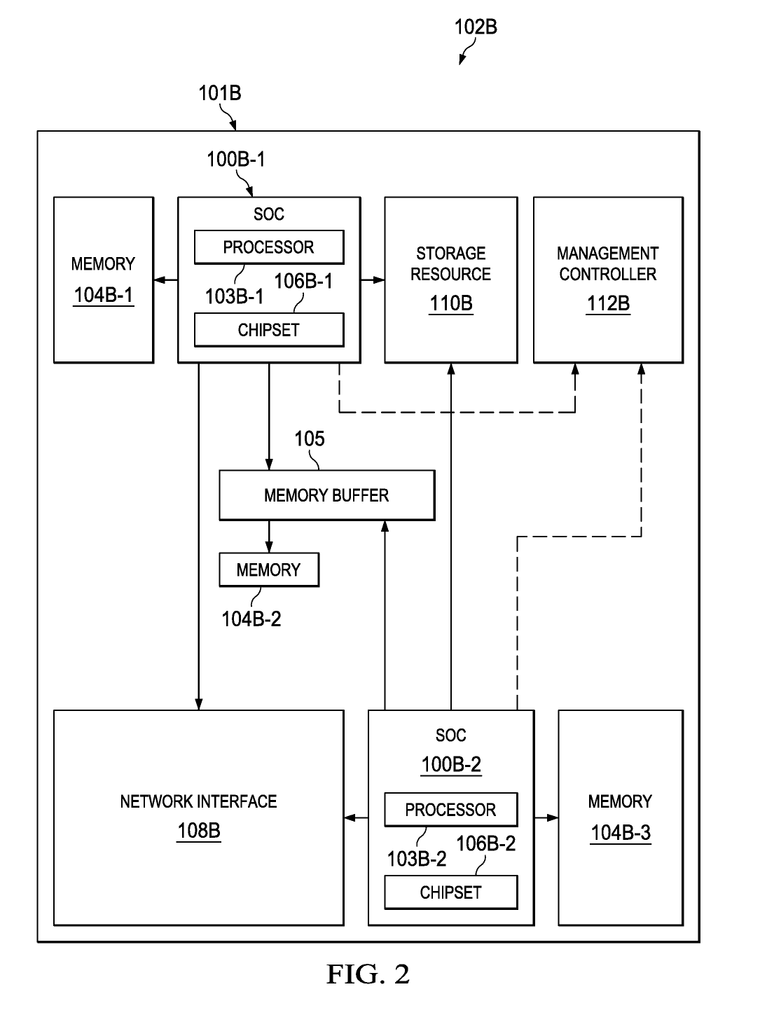

FIG. 2 illustrates a block diagram of an example information handling system 102B, in accordance with embodiments of the present disclosure. In some embodiments, information handling system 102B may comprise or be an integral part of a server. As depicted in FIG. 2, information handling system 102B may include a motherboard 101B.

Motherboard 101B may include a circuit board configured to provide structural support for one or more information handling resources of information handling system 102B and/or electrically couple one or more of such information handling resources to each other and/or to other electric or electronic components external to information handling system 102B. As shown in FIG. 2, motherboard 101B may comprise a plurality of systems on a chip (SOCs) 100B (e.g., SOC 100B-1 and SOC 100B-2), a plurality of memories 104B (e.g., memory 104B-1, memory 104B-2, memory 104B-3), a shared memory buffer 105 communicatively coupled to SOCs 100B, a shared storage resource 110B communicatively coupled to SOCs 100B, a shared network interface 108B communicatively coupled to SOCs 100B, and a management controller 112B communicatively coupled to SOCs 100B.

An SOC 100B may comprise an integrated circuit that integrates multiple components of an information handling system into a single integrated circuit package. As shown in FIG. 1, an SOC 100B may include a processor 103B (e.g., processor 103B-1 and processor 103B-2) and a chipset 106B (e.g., chipset 106B-1 and chipset 106B-2) communicatively coupled to processor 103B.

A processor 103B may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103B may interpret and/or execute program instructions and/or process data stored in a memory 104B and/or another component of information handling system 102B.

A chipset 106B may include any system, device, or apparatus configured to control certain data paths (e.g., data flow between a processor 103B and other components of information handling system 102B) and/or interactions of components of information handling system 102B. Thus, a chipset 106B may include a set of specialized chips for allowing communication between various components of information handling system 102B. For example, a chipset 106B may include northbridge and southbridge chips linking its associated processor 103B for I/O communication with other components or peripherals of information handling system 102B, e.g., a memory 104B, storage resource 110B, network interface 108B, and/or management controller 112B.

In embodiments of the present disclosure, processors 103B-1 and 103B-2 may be heterogeneous with respect to each other, meaning the processors 103B significantly differ in at least one material respect (e.g., vendor, processing capability, etc.).

A dedicated memory 104B (e.g., memories 104B-1 and 104B-2) may be communicatively coupled to an associated processor 103B via a chipset 106B and may include any system, device, or apparatus configured to retain program instructions and/or data for a period of time (e.g., computer-readable media). A shared memory 104B (e.g., memory 104B-3) may be communicatively coupled to both processors 103B-1 and 103B-2 via their respective chipsets 106B and a shared memory buffer 105 interfaced between memory 104-3 and SOCs 100B. A memory 104B may include RAM, EEPROM, a PCMCIA card, flash memory, magnetic storage, opto-magnetic storage, or any suitable selection and/or array of volatile or non-volatile memory that retains data after power to information handling system 102B is turned off.

Network interface 108B may comprise any suitable system, apparatus, or device operable to serve as an interface between information handling system 102B and/or one or more other information handling systems. Network interface 108B may enable information handling system 102B to communicate using any suitable transmission protocol and/or standard. In these and other embodiments, network interface 108B may comprise a network interface card, or “NIC.” In these and other embodiments, network interface 108B may comprise a multi-host NIC or multi-ported NIC in order to facilitate network interface 108B being shared among SOCs 100B.

Storage resource 110B may be communicatively coupled to both processors 103B-1 and 103B-2 via their respective chipsets 106B. Storage resource 110B may include any system, device, or apparatus operable to store information processed by processor 103B. Storage resource 110B may include, for example, one or more direct access storage devices (e.g., hard disk drives).

Management controller 112B may be configured to provide out-of-band management facilities for management of information handling system 102B. Such management may be made by management controller 112B even if information handling system 102B is powered off or powered to a standby state. In certain embodiments, management controller 112B may include or may be an integral part of a baseboard management controller (BMC), a remote access controller (e.g., a Dell Remote Access Controller or Integrated Dell Remote Access Controller), or an enclosure controller. In other embodiments, management controller 112B may include or may be an integral part of a chassis management controller (CMC).

In addition to motherboard 101B, processors 103B, chipsets 106B, memories 104B, memory buffer 105, network interface 108B, storage resource 110B, and management controller 112B, information handling system 102B may include one or more other information handling resources.

As shown, in information handling system 102B, each SOC 100B may have some information handling resources solely dedicated to such SOC 100B (e.g., dedicated memories 104B-1 and 104B-2) and not accessible to another SOC 100B within information handling system 102B. In addition, in information handling system 102B, one or more information handling resources other than management controller 112B (e.g., memory buffer 105, shared memory 104B-2, network interface 108B, and storage resource 110B) may be shared among SOCs 100B.

In operation, upon a boot or other initialization of information handling system 102B, management controller 112B may (e.g., based on a user selection or other configuration) select which of SOC 100B-1 and SOC 100B-2 may be enabled during such boot session, and the dedicated information handling resources associated with the selected SOC 100B may be discovered and powered on during the boot process, with management controller 112B properly allocating the shared information handling resources to the selected SOC 100B. In some embodiments, management controller 112B may (e.g., based on a user selection or other configuration) enable both of SOC 100B-1 and SOC 100B-2 during a boot session, with management controller 112B properly allocating portions of the shared information handling resources among the selected SOCs 100B.

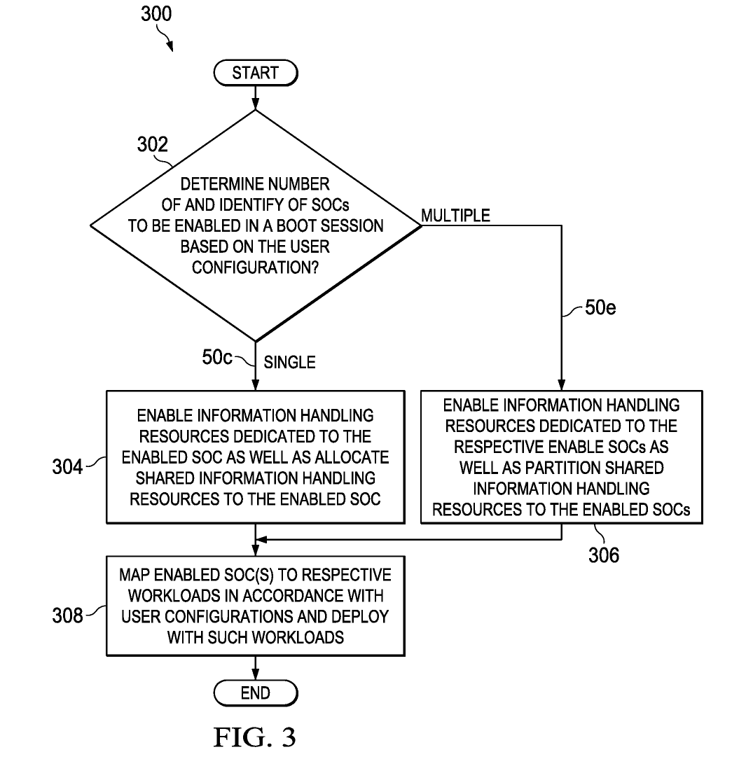

FIG. 3 illustrates a flow chart of an example method 300 for configuring an information handling system having heterogeneous processors on a single motherboard, in accordance with embodiments of the present disclosure. According to some embodiments, method 300 may begin at step 302. As noted above, teachings of the present disclosure may be implemented in a variety of configurations of information handling systems 102. As such, the preferred initialization point for method 300 and the order of the steps comprising method 300 may depend on the implementation chosen.

At step 302, a management controller may receive a user configuration and based on the user configuration determine the number of and identity of SOCs to be enabled in a boot session. If a single SOC is to be enabled, method 300 may proceed to step 304. If multiple SOCs are to be enabled, method 300 may proceed to step 306.

At step 304, the management controller may enable information handling resources dedicated to the enabled SOC as well as allocate shared information handling resources to the enabled SOC. After completion of step 304, method 300 may proceed to step 308.

At step 306, the management controller may enable information handling resources dedicated to the respective enabled SOCs as well as partition shared information handling resources to the enabled SOCs.

At step 308, the management controller may map the enabled SOC(s) to respective workloads in accordance with user configurations and deploy such workloads.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. An information handling system comprising a circuit board comprising:
a first system on a chip having a first processor;
a second system on a chip having a second processor, the first processor and the second processor being heterogeneous with respect to one another; and
a management controller communicatively coupled to the first system on a chip and the second system on a chip and configured to, based on a user configuration, select one or both of the first system on a chip and the second system on a chip for enablement during a boot session of the information handling system.

2. The information handling system of claim 1, further comprising:
a first set of information handling resources dedicated to the first system on a chip; and
a second set of information handling resources dedicated to the second system on a chip;
wherein the management controller is further configured to:
enable the first set of information handling resources for use by the first system on a chip when the first system on a chip is enabled; and
enable the second set of information handling resources for use by the second system on a chip when the second system on a chip is enabled.

3. The information handling system of claim 2, further comprising a third set of information handling resources shared between the first system on a chip and the second system on a chip, wherein the management controller is further configured to:
enable the third set of information handling resources for use by the first system on a chip when the first system on a chip is enabled and the second system on a chip is disabled; and
enable the third set of information handling resources for use by the second system on a chip when the second system on a chip is enabled and the first system on a chip is disabled.

4. The information handling system of claim 2, further comprising a third set of information handling resources shared between the first system on a chip and the second system on a chip, wherein the management controller is further configured to partition the third set of information handling resources between the first system on a chip and the second system on a chip when the first system on a chip and the second system on a chip are enabled.

5. The information handling system of claim 1, further comprising a set of information handling resources shared between the first system on a chip and the second system on a chip, wherein the management controller is further configured to:
enable the set of information handling resources for use by the first system on a chip when the first system on a chip is enabled and the second system on a chip is disabled; and
enable the set of information handling resources for use by the second system on a chip when the second system on a chip is enabled and the first system on a chip is disabled.

6. A method comprising, in a circuit board comprising a first system on a chip having a first processor and a second system on a chip having a second processor, the first processor and the second processor being heterogeneous with respect to one another:
receiving a user configuration; and
based on the user configuration, selecting one or both of the first system on a chip and the second system on a chip for enablement during a boot session of an information handling system comprising the circuit board.

7. The method of claim 6, further comprising:
enabling a first set of information handling resources dedicated to the first system on a chip for use by the first system on a chip when the first system on a chip is enabled; and
enabling the second set of information handling resources dedicated to the second system on a chip for use by the second system on a chip when the second system on a chip is enabled.

8. The method of claim 7, further comprising:
enabling a third set of information handling resources shared between the first system on a chip and the second system on a chip for use by the first system on a chip when the first system on a chip is enabled and the second system on a chip is disabled; and
enabling the third set of information handling resources for use by the second system on a chip when the second system on a chip is enabled and the first system on a chip is disabled.

9. The method of claim 7, further comprising partitioning a third set of information handling resources shared between the first system on a chip and the second system on a chip between the first system on a chip and the second system on a chip when the first system on a chip and the second system on a chip are enabled.

10. The method of claim 6, further comprising:
enabling a set of information handling resources shared between the first system on a chip and the second system for use by the first system on a chip when the first system on a chip is enabled and the second system on a chip is disabled; and
enabling the set of information handling resources for use by the second system on a chip when the second system on a chip is enabled and the first system on a chip is disabled.

11. An article of manufacture comprising:
a non-transitory computer-readable medium; and
computer-executable instructions carried on the computer readable medium, the instructions readable by a processor, the instructions, when read and executed, for causing the processor to, in a circuit board comprising a first system on a chip having a first processor and a second system on a chip having a second processor, the first processor and the second processor being heterogeneous with respect to one another:
receive a user configuration; and
based on the user configuration, select one or both of the first system on a chip and the second system on a chip for enablement during a boot session of an information handling system comprising the circuit board.

12. The article of claim 11, the instructions for further causing the processor to:
enable a first set of information handling resources dedicated to the first system on a chip for use by the first system on a chip when the first system on a chip is enabled; and
enable the second set of information handling resources dedicated to the second system on a chip for use by the second system on a chip when the second system on a chip is enabled.

13. The article of claim 12, the instructions for further causing the processor to:
enable a third set of information handling resources shared between the first system on a chip and the second system on a chip for use by the first system on a chip when the first system on a chip is enabled and the second system on a chip is disabled; and
enable the third set of information handling resources for use by the second system on a chip when the second system on a chip is enabled and the first system on a chip is disabled.

14. The article of claim 12, the instructions for further causing the processor to partition a third set of information handling resources shared between the first system on a chip and the second system on a chip between the first system on a chip and the second system on a chip when the first system on a chip and the second system on a chip are enabled.

15. The article of claim 11, the instructions for further causing the processor to:
enable a set of information handling resources shared between the first system on a chip and the second system for use by the first system on a chip when the first system on a chip is enabled and the second system on a chip is disabled; and
enable the set of information handling resources for use by the second system on a chip when the second system on a chip is enabled and the first system on a chip is disabled.
